(19) United States
(12) Patent Application Publication
(10) Pub. No.: US 2003/0016625 A1
(43) Pub. Date: Jan. 23, 2003

(54) Preclassifying traffic during periods of oversubscription

(76) Inventors: Anees Narsinh, Pacific Palisades, CA (US); James A. Hitzelberger, Westlake Village, CA (US); Jean-Francois Cartier, Treillieres (FR); Levillain Philippe, Agoura Hills, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/068,710

(22) Filed: Feb. 6, 2002

Related U.S. Application Data
(60) Provisional application No. 60/307,269, filed on Jul. 23, 2001.

(51) Int. Cl. H04J 1/16

(52) U.S. Cl. 370/230; 370/444

(57) ABSTRACT

A system and method for traffic congestion control at the media access controller (MAC) level. The MAC receives an inbound packet and preclassifies the packet for determining its priority. A utilization level of a queue associated with the determined priority is analyzed for determining its level of congestion. The packet is admitted or not based on the congestion information. Admitted packets are forwarded to the packet switching controller which engages in further classification and congestion control for determining whether the admitted packet is to be forwarded to a destination address.

### FIELD OF THE INVENTION

This invention relates generally to controlling traffic passing through a data communication switch, and more particularly, to preclassifying traffic at a media access controller for traffic congestion control.

### BACKGROUND OF THE INVENTION

Because data connections tend to be used intermittently, oversubscription of a port of a data communication switch is generally an effective strategy for achieving more economical network connectivity. Oversubscription is achieved by assigning a total peak information rate for one or more ports that is greater than the capabilities of a downstream device.

Oversubscription increases the volume of traffic supported by a switching network, leaving the network more prone to congestion. Existing congestion control mechanisms are typically implemented at a switching controller level of the data communication switch. Generally, a media access controller (MAC) resident in the switch receives incoming packets and provides them to the switching controller at its wire speed as long as the switching controller is capable of accepting the packets. The packets are transmitted to the switching controller without regard to the type of priority associated with the incoming packets.

If the switching controller stops accepting packets, the MAC attempts to store the packets in a temporary buffer, again without any regard to the priority of the packets. Unfortunately, when the temporary buffer is full, the MAC generally discards further incoming packets until space becomes available again. The incoming packets are dropped even if they are associated with a high priority.

There is a need, therefore, for a data switch that provides oversubscription traffic management at the MAC level in addition to the traffic management at the switching controller level. The traffic management at the MAC level should, whenever possible, allow high priority packets to pass to the switching controller and drop low priority packets.

### SUMMARY OF THE INVENTION

The present invention is directed to an oversubscription traffic management at an access controller level.

According to one embodiment of the invention, a data communication node forwarding inbound packets includes an access controller and a switching controller. The access controller receives an inbound packet, classifies the packet, and determines whether the packet is to be admitted or not based on congestion status data determined from the classification information. If the packet is admitted, the switching controller receives the admitted packet for further classifying the packet and determines whether the packet is to be forwarded to a destination address or not based on additional congestion status data determined from additional classification information.

In another embodiment of the invention, an access controller in a data communication node includes an input receiving an inbound packet, a classification engine coupled to the input classifying the inbound packet, a buffer storing admitted inbound packets, and a disposition engine coupled to the classification engine and the buffer. The disposition engine receives the classification information and determines whether the inbound packet is to be admitted or not based on a utilization level of the buffer determined from the classification information. The disposition engine delivers the inbound packet to a switching controller, if the packet is admitted, for determining whether the admitted packet is to be forwarded to a destination address.

In a further embodiment of the invention, a method is provided for packet traffic management in a data communication node that includes an access controller and a switching controller. The method includes, at the access controller, receiving an inbound packet, classifying the inbound packet, and obtaining congestion status data from the classification information, admitting the inbound packet or not based on the congestion status data, and delivering the inbound packet to the switching controller if the packet is admitted. The method further includes, at the switching controller, determining whether the admitted packet is to be forwarded to a destination address.

It should be appreciated, therefore, that the present invention allows packets to be preclassified at an access controller level for use in determining whether the packet is to be admitted and forwarded to the switching controller. The preclassification and congestion avoidance mechanism at the access controller allow packets of higher priority to be admitted over packets of lower priority. Thus, the problem of the prior art of indiscriminately dropping packets when the packet buffer is full is avoided.

### BRIEF DESCRIPTION OF THE DRAWINGS

These and other features, aspects and advantages of the present invention will be more fully understood when considered with respect to the following detailed description, appended claims, and accompanying drawings where:

FIG. 1 is a schematic block diagram of a packet switching node according to one embodiment of the invention;

FIG. 2 is a schematic block diagram of a switching interface according to one embodiment of the present invention;

FIG. 3 is schematic block diagram of an access controller according to one embodiment of the present invention; and

FIG. 4 is a flow diagram of a process for traffic congestion control at an access controller level according to one embodiment of the invention.

### DETAILED DESCRIPTION OF THE SPECIFIC EMBODIMENTS

FIG. 1 is a schematic block diagram of a packet switching node 10 according to one embodiment of the invention. The packet switching node may also be referred to as a switch, a data communication node, or a data communication switch. The packet switching node 10 includes switching interfaces 14, 16 and 18 interconnected to respective groups of local area networks (LANs) 30, 32, 34, and interconnected to one another over data paths 20, 22, 24 via switching backplane 12. The switching backplane 12 preferably includes a switching fabric in a manner that is conventional in the art. The switching interfaces may also be coupled to one another over control paths 26 and 28.

The switching interfaces 14, 16, 18 preferably forward packets to and from their respective groups of LANs 30, 32, 34 in accordance with one or more operative communication protocols, such as, for example, media access control (MAC) address based bridging, and Internet Protocol (IP) routing. The switching node 10 is shown for illustrative purposes only. In practice, packet switching nodes may include more or less than three switching interfaces.

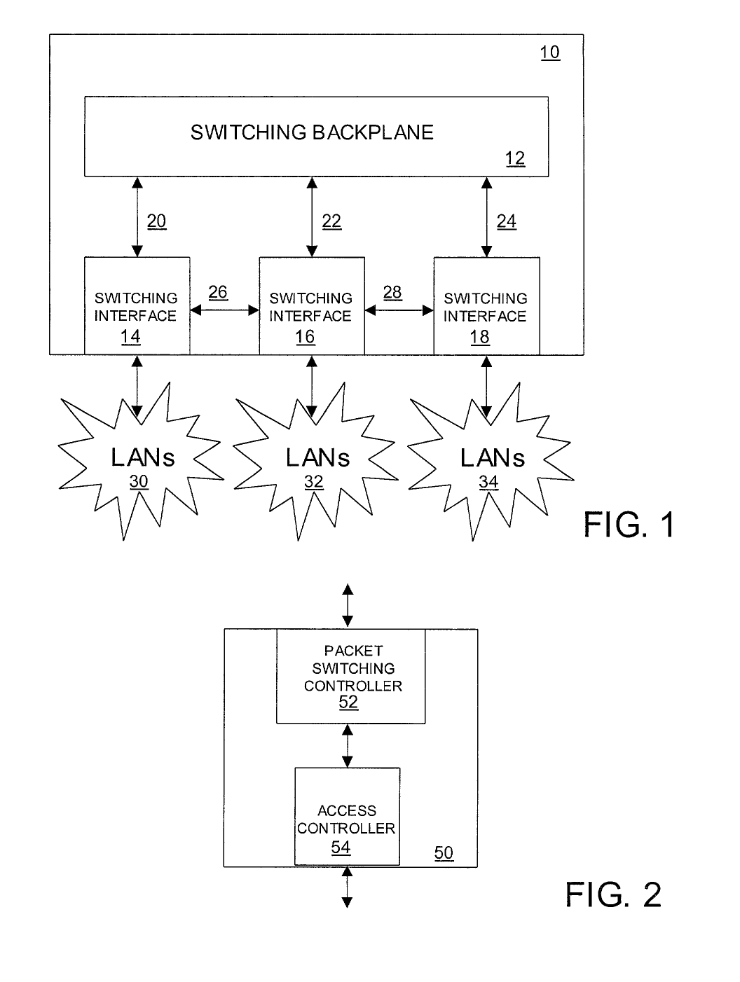

FIG. 2 is a schematic block diagram of a switching interface 50 according to one embodiment of the present invention. The switching interface 50 may be similar, for example, to the switching interfaces 14, 16, 18 of FIG. 1. The switching interface 50 includes an access controller 54 coupled between LANs and a packet switching controller 52. The access controller 54, which may, for example, include a media access controller (MAC), preferably receives inbound packets off LANs, performs physical and MAC layer operations on the inbound packets, and transmits the inbound packets to the packet switching controller 52 for flow-dependent processing. According to one embodiment of the invention, the access controller 54 performs access control operations including preclassification of inbound packets for determining whether the inbound packets are to be admitted based on the preclassification information and a detected congestion level.

The packet switching controller 52 preferably receives the admitted packets forwarded by the access controller 54, classifies the packets, and queues them for downstream congestion control. If the admitted packets are to be forwarded to their destination address based on the congestion control mechanism at the switching controller, the packet switching controller modifies the packets in accordance with flow information and transmits the modified packets on a switching backplane, such as the switching backplane 12 of FIG. 1.

The packet switching controller 52 preferably also receives packets modified by other packet switching controllers via the switching backplane and transmits them to the access controller 54 for forwarding on LANs. The packet switching controller 52 may also subject selected ones of the packets to egress processing prior to transmitting them to the access controller 54 for forwarding on LANs.

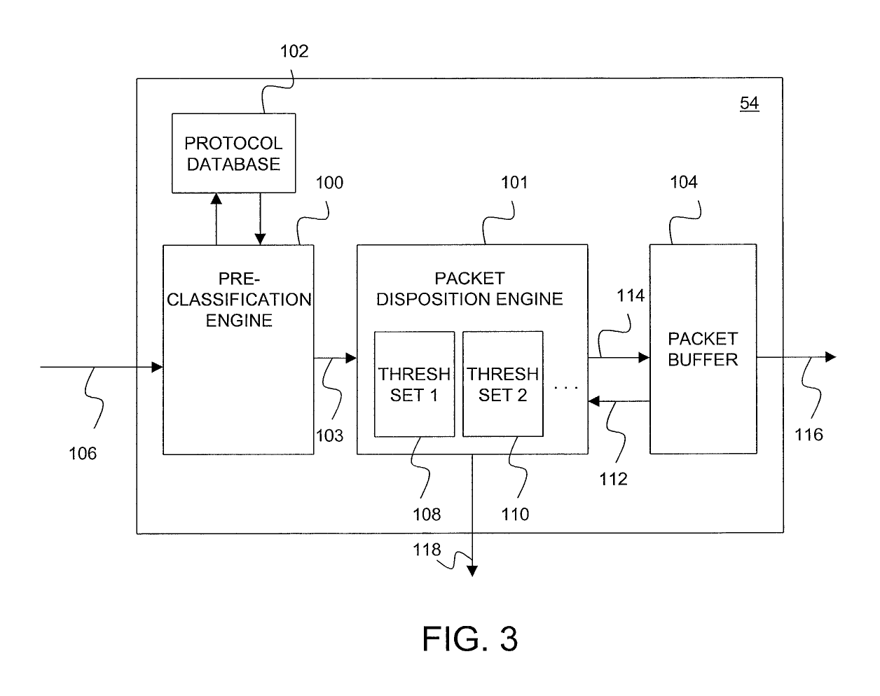

FIG. 3 is a more detailed block diagram of the access controller 54 according to one embodiment of the present invention. The access controller 54 preferably includes a packet preclassification engine 100, packet disposition engine 101, protocol database 102, and packet buffer 104. Although the packet preclassification engine 100 and packet disposition engine 101 are illustrated as separate engines, a person skilled in the art should recognize that they may be combined into a single engine or distributed over multiple engines.

It is also understood, of course, that FIG. 3 illustrates a block diagram of an access controller without obfuscating inventive aspects of the present invention with additional elements and/or components which may be required for the access controller. These additional elements and/or components, which are not shown in FIG. 3, are well known to those skilled in the art.

The packet preclassification engine 100 is preferably coupled to the protocol database 102 for preclassifying inbound packets 106 based on information contained in the protocol database. The packet preclassification engine 100 is preferably implemented in an application-specific integrated circuit (ASIC). The protocol database 102 is preferably a form of content addressable memory (CAM) storing Layer 3 protocol identifiers and their associated priorities. The packet preclassification engine 100 assigns a priority to the inbound packets 106 based on the protocol information and/or other header data such as, for example, 802.1P/Q tag status, Layer 2 encapsulation type, ToS (type of service) values, other connection information, embedded priority information, and/or the like.

The preclassification information 103 is transmitted to the packet disposition engine 101 for determining whether the inbound packets 106 are to be admitted based on the preclassification information and one or more thresholds 108, 110 set for the packet buffer 104. The packet disposition engine 101 is preferably implemented in an ASIC.

The packet buffer 104 preferably includes one or more queues for storing the inbound packets 106 that have been admitted by the packet disposition engine 101. According to one embodiment of the invention, the packet buffer 104 includes queues having different priorities for storing packets 106 based on their priority. The packets stored in the queues are dequeued and forwarded to the switching controller 52, preferably based on a priority-based dequeueing which is commonly referred to as class-based dequeuing. A person skilled in the art should recognize, however, that other algorithms may also be utilized for dequeuing the packets, such as, for example, a paycheck round robin algorithm or deficit round robin algorithm.

In general terms, the access controller 54 receives the inbound packets 106 via an input, such as an inbound cable. The inbound packets 106 may include, but are not limited to, Ethernet frames, ATM cells, TCP/IP and/or UDP/IP packets, and may consist of Layer 2 (Data Link/MAC Layer), Layer 3 (Network Layer), Layer 4 (Transport Layer), or Layer 5 (ATM Adaptation Layer) data units. All or portions of the inbound packet are transmitted to the packet preclassification engine 100 for preclassification. In this regard, the packet preclassification engine 100 preferably examines an inbound packet's header data and preclassifies the packet for determining its priority. According to one embodiment of the invention, the preclassification engine 100 accesses the protocol database 102 and determines the packet's priority based on its protocol information. According to another embodiment of the invention, the packet's priority is determined based on the packet's information, encapsulation type, ToS values, other connection information, embedded priority information, and/or the like.

The preclassification information and/or all or portions of the inbound packet is transmitted to the packet disposition engine 101. The packet disposition engine determines whether the packet is to be admitted or dropped based on the preclassification information and detected congestion level of the packet buffer 104. The packet disposition engine 101 preferably invokes a weighted random early discard (WRED) algorithm for determining whether the preclassified packet is to be dropped or admitted. The WRED algorithm is a derivative of the RED algorithm, both of which are well known to those skilled in the art. The RED algorithm is described in detail in S. Floyd et. al, “Random Early Detection Gateways for Congestion Avoidance,” IEE/ACM Transactions on Networking, 1(4) :397-413, August 1993, the content of which is incorporated herein by reference. A person skilled in the art should recognize that the packet disposition engine 101 may utilize other algorithms for determining whether a packet is to be admitted, such as, for example, strict priority, weighted round robin, or other traffic shaping methods which are well known to those skilled in the art.

Preferably, the packet disposition engine 101 maintains at least two thresholds for each priority queue in the packet buffer 104, a minimum threshold and a maximum threshold. If a RED or WRED congestion control algorithm is utilized, the packet disposition engine further maintains a discard probability for each priority. According to one embodiment of the invention, the thresholds and discard probabilities set for the queues vary based on their priorities.

The packet disposition engine 101 preferably receives periodic updates 112 about the level of utilization of the packet buffer 104 for comparing against the minimum and maximum thresholds. According to one embodiment of the invention, the thresholds are recomputed based on the periodic updates 112.

According to both the RED and WRED algorithms, if the number of packets contained in a queue of the packet buffer 104 is less than a minimum threshold, the packet disposition engine 101 admits the inbound packet 106 destined for the queue and adds it to the queue. If the number of packets contained in the queue is more than the maximum threshold, the packet disposition engine 101 discards the packet. If the queue contains packets in between the minimum and maximum thresholds, the packet disposition engine 101 preferably discards the inbound packet according to a pre-determined discard probability associated with the queue.

Packets that are not dropped by the packet disposition engine 101 are admitted into the node and passed 114 to the packet buffer 104 for storage. Packets that are stored are preferably held in a common buffer where the utilization for each priority is monitored. When ready to be forwarded to the packet switching controller, the packet buffer 104 dequeues the packets, preferably according to a class based dequeuing, where packets in the higher priority queues are dequeued before packets in the lower priority queues. This allows higher priority queues to be emptied before lower priority queues, causing higher priority packets destined for the high priority queues to be admitted more often than lower priority packets. The dequeued packets are forwarded as outgoing packets 116 to the packet switching controller 52.

The packet switching controller 52 receives the admitted packets and engages in further classification of the packets. The admitted packets may be classified for determining their priority, and recommended to be dropped or forwarded to their destination address based on the classification information and congestion at the switching controller level.

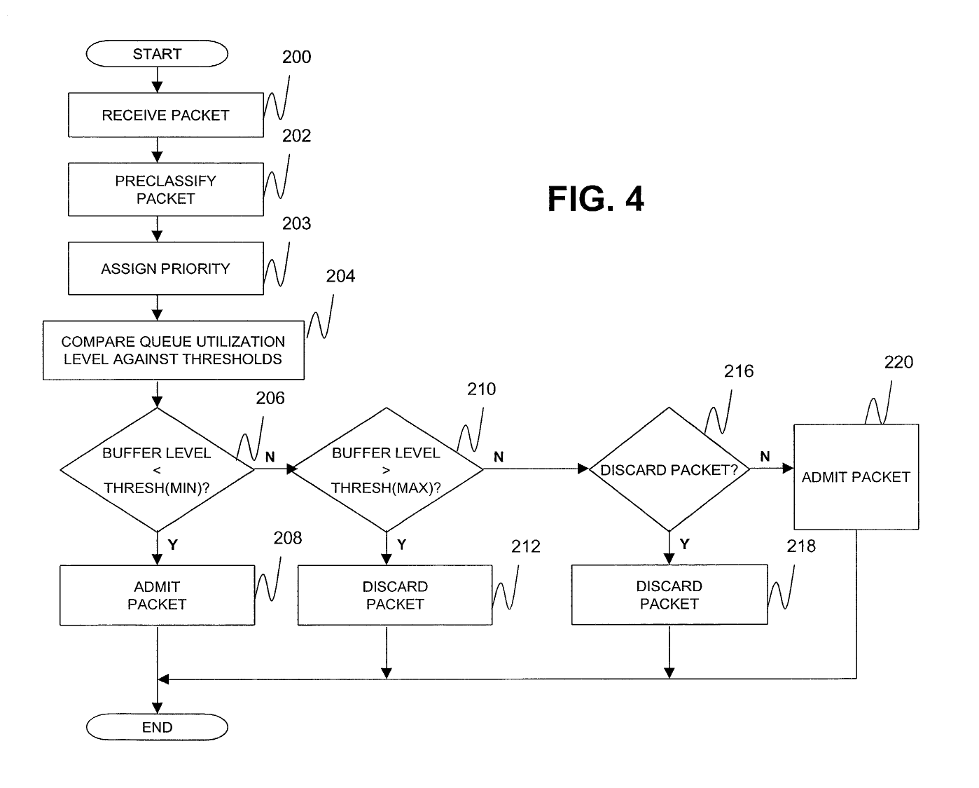

FIG. 4 is a flow diagram of a process for traffic congestion control at an access controller level according to one embodiment of the invention. The process starts, and in step 200, the packet preclassification engine 100 receives an inbound packet. In step 202, the packet preclassification engine 100 preclassifies the packet and determines a priority associated with the packet. In step 203, the packet preclassification engine 203 assigns the determined priority to the packet.

In step 204, the packet disposition engine 101 receives the priority information and compares the utilization level of the associated queue in the packet buffer 104 against minimum and maximum thresholds set for the queue. If a determination is made, in step 206, that the queue utilization level is less than the set minimum threshold, the packet is admitted in step 208 for forwarding to the packet switching controller 52.

If, on the other hand, a determination is made, in step 210, that the queue utilization level is greater than the set maximum threshold, the packet is discarded in step 212. Otherwise, the queue utilization level is between the minimum and maximum thresholds, and the packet preclassification engine, in step 216, determines if the packet is to be discarded based on the discard probability set for the priority assigned to the packet. If the answer is YES, the packet disposition engine 101 discards the packet in step 218. Otherwise, the packet is admitted in step 220.

Although this invention has been described in certain specific embodiments, those skilled in the art will have no difficulty devising variations which in no way depart from the scope and spirit of the present invention. It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

1. A data communication node forwarding inbound packets, the node comprising:
an access controller receiving an inbound packet and classifying the packet, the access controller determining whether the packet is to be admitted into the node or not based on congestion status data determined from the classification information; and
a switching controller coupled to the access controller, the switching controller receiving the admitted inbound packet from the access controller for further classifying the packet, the switching controller determining whether the packet is to be forwarded to a destination address or not based on additional congestion status data determined from additional classification information.

2. The data communication node of claim 1, wherein the access controller is a media access controller.

3. The data communication node of claim 1, wherein the classification information includes a priority associated with the inbound packet.

4. The data communication node of claim 3, wherein the access controller gives precedence in admitting packets associated with a first priority over packets associated with a second priority.

5. The data communication node of claim 1, wherein the access controller includes a buffer storing admitted inbound packets.

6. The data communication node of claim 5, wherein the congestion status data includes a buffer utilization level, the access controller admitting the inbound packet if the utilization 10 level is lower than a predetermined threshold level.

7. The data communication node of claim 5, wherein the congestion status data includes a buffer utilization level, the access controller discarding the inbound packet if the utilization level is higher than a predetermined threshold level.

8. The data communication node of claim 1, wherein the access controller discards the inbound packet based on a discard probability that varies based on the classification information.

9. An access controller in a data communication node comprising:
an input receiving an inbound packet;
a classification engine coupled to the input classifying the inbound packet;
a buffer storing admitted inbound packets; and
a disposition engine coupled to the classification engine and the buffer, the disposition engine receiving the classification information and determining whether the inbound packet is to be admitted or not based on a utilization level of the buffer determined from the classification information, the disposition engine delivering the inbound packet to a switching controller if the packet is admitted.

10. The access controller of claim 9, wherein the classification information includes a priority associated with the inbound packet.

11. The access controller of claim 10, wherein the disposition engine gives precedence in admitting packets associated with a first priority over packets associated with a second priority.

12. The access controller of claim 9, wherein the disposition engine admits the inbound packet if the utilization level of the buffer is lower than a predetermined threshold level.

13. The access controller of claim 9, wherein the disposition engine discards the inbound packet if the utilization level of the buffer is higher than a predetermined threshold level.

14. The access controller of claim 9, wherein the disposition engine discards the inbound packet based on a discard probability that varies based on the classification information.

15. A method for packet traffic management in a data communication node including an access controller and a switching controller, the method comprising:
at the access controller:
receiving an inbound packet;
classifying the inbound packet;
determining congestion status data from the classification information;
admitting the inbound packet or not based on the congestion status data; and
delivering the inbound packet to the switching controller if the packet is admitted; and
at the switching controller, determining whether the admitted packet is to be forwarded to a destination address.

16. The method of claim 15, wherein the access controller is a media access controller.

17. The method of claim 15, wherein the classification information includes a priority associated with the inbound packet.

18. The method of claim 17, wherein the admitting the inbound packet further comprises giving precedence to packets associated with a first priority over packets associated with a second priority.

19. The method of claim 17 further comprising storing the inbound packet in a packet buffer associated with the access controller if the packet is admitted.

20. The method of claim 19, wherein the determining of the congestion status data comprises determining a utilization level of the packet buffer.

21. The method of claim 20, wherein the admitting of the inbound packet comprises admitting the inbound packet if the utilization level of the packet buffer is lower than a predetermined threshold level.

22. The method of claim 20 further comprising discarding the inbound packet if the utilization level of the packet buffer is higher than a predetermined threshold level.

23. The method of claim 20 further comprising discarding the inbound packet based on a discard probability that varies based on the classification information.
